(19) United States
(12) Patent Application Publication
(10) Pub. No.: US 2008/0151194 A1
(43) Pub. Date: Jun. 26, 2008

(54) Method and System for Illumination Adjustment

(76) Inventor: Avner Segev, Tel Mond (IL)

Correspondence Address: THE NATH LAW GROUP, 112 South West Street, Alexandria, VA, 22314, US

(21) Appl. No.: 11/883,515

(22) PCT Filed: Jan. 31, 2006
(86) PCT No.: PCT/IL06/00125

§ 371 Date: Dec. 31, 2007

(51) Int. Cl. G03B 21/26

(52) U.S. Cl. 353/28

(57) ABSTRACT

A method and system are provided for illuminating and imaging an object, wherein the illumination of the object is controlled by means of feedback based on the light intensity obtained from the object using one method of illumination, such as to provide a modified illumination that will result in a more uniform reflectance from the object.

### FIELD OF THE INVENTION

This invention relates to illumination and imaging systems and methods. In particular, the invention relates to such systems and methods that may be applied to 3D surface reconstruction and other optical measurements.

### BACKGROUND OF THE INVENTION

Imaging and optical measurement of objects, particularly when obtained via electronic imaging equipment (also referred to as “machine vision”), can sometimes be of poor quality or inaccurate when there is an imbalance in the intensity of light reflected therefrom from an illumination optics, whether natural or artificial. While the illumination optics may provide a uniform illumination to the object in question, there may sometimes be large reflectance variations of the measured object surface due to variations in surface characteristics, for example, and such reflectance variations may be difficult to deal with. Large-scale industrial objects such as metal parts used in the automotive industry, printed circuit boards (PCB), plastic parts and so on, often have large variation in their optical properties due to change in color or texture of the object, surface roughness changes, difference in materials, etc. When imaging a surface of such objects illuminated with uniform illumination, the resultant image may sometimes be dark in some areas of the image while highlighted areas cause saturation and loss of information in other parts of the image. Similar situations can sometimes arise when illuminating an object via an illumination light transmitted through the object, for example in microscopy.

Standard methods for dealing with this issue mostly focus on enlarging the dynamic range of the image sensor. These include the use of large dynamic range CCD sensors with linear response of up to 16 bit, or CMOS sensors with nonlinear response (logarithmic, linear with variable slope, etc.). Other techniques utilize several exposures with varying exposure times of the image sensor, and fuse the images to one single image using various algorithms.

Other methods incorporate different illumination schemes, including, for example, the use of polarization effects to reduce highlights in specular reflecting surface areas, illuminating from multiple angles, and using light sources of different color.

In “Programmable Imaging Using a Digital Array” (S. K. Nayar, V. Branzoi, and T. Boult, Proceedings of IEEE Conference on Computer Vision and Pattern Recognition, Washington D.C., June 2004), a digital micro-mirror device has a plurality of individually controllable micro-mirrors that are each tiltable about one axis, and is used to dynamically deflect micro beams of light from an illuminated object between a CCD and a black surface such as to attenuate the light received at each pixel of the CCD.

### SUMMARY OF THE INVENTION

The present invention relates to an illumination system for controlling illumination of an object, and also to a corresponding imaging system for imaging an illuminated object, comprising:
(a) at least one programmable illumination unit capable of projecting an illumination radiation with respect to an object, said illumination unit being adapted for enabling portions of said illumination radiation are individually controllable via suitable control instructions;
(b) at least one image acquisition device (also interchangeably referred to herein as imaging device) for acquiring at least one image of an object illuminated by said illumination unit; and
(c) a control unit operatively connected to said at least one illumination unit and said at least one imaging device, said control unit being configured for creating control instructions for controlling operation of said at least one illumination unit based on analysis of at least one image obtained from said at least one imaging device.

The at least one programmable illumination unit comprises at least one illumination source (herein also interchangeably referred to as a light source) capable of projecting an illumination radiation in optical communication with a plurality of optical elements, said optical elements being individually controllable via said suitable control instructions such that each optical element is capable of being selectively controlled for enabling or blocking projection of a corresponding portion of said illumination radiation with respect to an object that is to be illuminated by said illumination unit.

The illumination unit may be adapted for controlling the intensity of illumination of a corresponding part of the object at least as sensed by said at least one image acquisition device.

Said differently, the programmable illumination unit comprises at least one illumination source capable of projecting an illumination radiation in optical communication with a plurality of individually controllable optical elements, each optical element having at least two operative states: a first state in which the optical elements effectively block or otherwise prevent projection of a corresponding portion of said illumination radiation with respect to an object that is to be illuminated by said illumination unit, and a second state in which the optical elements enable illumination of the object, responsive to suitable control instructions. The amount of illumination of the object allowed (or the degree by which the illumination is effectively blocked) by each optical element in the second state is optionally controllable to provide a desired intensity of illumination between a maximum and a minimum illumination intensity.

In one embodiment, each illumination unit comprises a plurality of optical elements configured for selectively allowing or preventing optical communication therethrough of said illumination radiation with respect to an object, responsive to said control instructions. For example, the illumination unit may comprise a liquid crystal display (LCD) array in optical communication with said illumination source, comprising a plurality of LCD elements individually controllable responsive to said control instructions to selectively control optical communication therethrough between a portion of said illuminating radiation and an object.

The LCD elements are individually controllable via said control instructions such as to provide a range of levels of optical transparencies between a minimum value, in which the corresponding LCD element allows substantially no illumination light therethrough, and a maximum value, in which the maximum illumination intensity is allowed to be projected therethrough towards the object.

Features of LCD-based illumination units include the following: LCD technology is very well developed and widely available, and provide good color representation; and such units are analogue devices, enabling the degree of illumination control to be controlled directly.

In another embodiment, the illumination unit comprises a digital light processing (DLP) arrangement comprising a plurality of optical elements configured for selectively reflecting, towards or away with respect to an object, a portion of said illumination radiation, responsive to said control instructions. For example, the illumination unit may comprise a digital micro-mirror device (DMD) in optical communication with said illumination source, and comprising a plurality of micro-mirror elements individually controllable responsive to said control instructions to selectively direct a portion of illumination radiation towards or away from an object.

The micro-mirror elements are individually controllable via said control instructions such as to attenuate the intensity of illumination light projected to the object, wherein each corresponding micro-mirror element is controlled to direct said illumination radiation towards the object for a proportion of an integration time of said at least one image acquisition device

Features of DLP-based illumination units include the following: DLP technology can be incorporated in small, lightweight portable illumination units; DMD's are digital devices, and grey levels can be produced by cycling on-off times in particular ratios using a pulsewidth modulation technique.

In other embodiments, the programmable illumination unit may be based on a Liquid Crystal on Silicon (LCOS) device. Features of LCOS-based illumination units include the following: LCOS technology is a new technology with potential for low cost manufacture; analogue devices with good color representation; high fill factor with no “screen door” effect; small pixels and high resolution may be provided.

In other embodiments, the programmable illumination unit may be based on a Grating Light Valve (GLV) device. Features of GLV-based illumination units include the following: GLV technology is suitable for monochromatic light sources; may be manufactured in a standard IC process, providing low cost, high resolution linear arrays.

The control unit is adapted for creating control instructions that enable each illumination unit to project, with respect to an object, an illumination having a rightness distribution that is generally inverse to the radiation intensity distribution, for example associated with reflectance from or transmittance through the object, of an image obtained from said at least one image acquisition unit when said object is illuminated with an illumination having a generally uniform brightness distribution.

Optionally, the control unit may be adapted for creating control instructions that enable the illumination unit to project, with respect to an object, a structured illumination wherein it is desired to illuminate an object with non-uniform illumination. Such non-uniform illumination may comprise a random pixel illumination, striped illumination, and so on, which may be used for reconstructing 3D topology of an object, for example.

Optionally, a plurality of image acquisition devices may be comprised in the system, and the control unit receives and processes image data from one of the image acquisition devices to generate the appropriate control instructions. Alternatively, the control unit receives and processes image data from a plurality of image acquisition devices to generate the appropriate control instructions based on composite image data obtained from the devices. Thus, in the latter case, image data from a number of imaging devices may be combined in any desired manner for subsequent processing to generate the control instructions.

Further optionally, the system may comprise a plurality of programmable illumination units, each of which is operatively connected to the same image acquisition device, or a different image acquisition device, and to the same or different control unit.

According to the invention, the illumination system may be set up such that the at least one programmable illumination unit is arranged to illuminate a surface of an object, and said at least one image acquisition device is arranged with respect to the object such as to provide an image of at least a part of said surface, said image being analyzable to determine associated reflectance data for use in creating said control instructions. In such a set up, an object, which may be generally optically opaque, is illuminated with foreground illumination.

Alternatively, the illumination system may be set up such that said at least one programmable illumination unit is arranged to provide illumination through at least a part an object, and said at least one image acquisition device is arranged with respect to the object such as to provide an image of at least a portion of said part of the object said image being analyzable to determine associated radiation transmission data for use in creating said control instructions. Such a set up is which may be generally transparent or and/or translucent opaque, is illuminated with background illumination, and may have particular use in microscopy applications and the like.

Herein, “control instructions” refers to computer readable instructions, digital instructions, electronic instructions or any other type of instructions capable of being received and carried out by the programmable illumination unit, and thus also refers to any manner of control signals that may be generated in order to control said programmable illumination unit.

The control unit may be further adapted for processing images obtained from said plurality of said image acquisition devices for 3D surface reconstruction or for optical measurement of an object. In such a case, the system may comprise a plurality of image acquisition devices, each capable of acquiring images from a different viewpoint one to the other with respect to the object being imaged.

The present invention thus also relates to a method for illuminating an object, comprising:
(a) projecting a first illumination radiation with respect to an object;
(b) acquiring at least one image of said object illuminated as in step (a);
(c) analyzing said at least one image to obtain radiation intensity data associated said image and correlated to said first illumination radiation; and
(d) projecting a second illumination radiation with respect to said object, whereby, at least a perceived intensity of, individual portions of said second illumination radiation are or may be modified with respect to corresponding portions of said first illumination radiation based on said radiation intensity data obtained in step (b).

Further, the present invention also relates to a method for imaging an object, comprising:
(a) projecting a first illumination radiation with respect to an object;
(b) acquiring at least one first image of said object illuminated as in step (a);
(c) analyzing said at least one first image to obtain radiation intensity data associated with said first image and correlated to said first illumination radiation;
(d) projecting a second illumination radiation with respect to said object, whereby individual portions of said second illumination radiation are modified with respect to corresponding portions of said first illumination radiation based on said radiation intensity data obtained in step (b); and
(e) acquiring at least one second image of said object illuminated as in step (d).

According to either method, the second illumination radiation may comprise a brightness distribution in general inverse relationship with respect a radiation intensity distribution (for example, reflectance distribution or transmittance distribution) of said image radiation intensity data obtained in step (b).

The first illumination radiation in step (a) is defined according to a basic white calibration procedure, including the following steps:—
(i) illuminating a standard calibration object with substantially uniform illumination;
(ii) acquiring at least one calibration image of said calibration object illuminated as in step (i);
(iii) analyzing said at least one calibration image to obtain radiation intensity data associated with said image and correlated to said uniform illumination radiation; and
(iv) generating said first illumination radiation, whereby individual portions of said first illumination radiation are modified with respect to corresponding portions of said uniform illumination radiation based on said radiation intensity data obtained in step (iii).

According to the invention, the method for imaging an object may further comprise processing said at least one second image for 3D surface reconstruction or for optical measurement of an object. In such a case, a plurality of sets of said second image may be obtained for 3D surface reconstruction or for optical measurement of an object, and the second images in each set may be obtained at a different viewpoints with respect to said object.

According to one embodiment, in step (d), an illuminating intensity of said portions of said second illumination radiation is directly controlled to provide a desired level of illumination at a corresponding part of the object.

According to another embodiment, in step (d), an illuminating intensity of said portions of said second illumination radiation, as perceived by an image acquisition device that provides said at least one image, is controlled such as to attenuate the intensity of illumination light projected to the object, wherein each said portion of said second illumination radiation is projected towards the object for a proportion of an integration time of said image acquisition device to provide a desired level of illumination at a corresponding part of the object.

The said first illumination radiation may be projected with respect to an object such that at least a part of said illumination is reflected in a direction from which said at least one image of said object is being acquired. Alternatively, the first illumination radiation is projected with respect to an object such that at least a part of said illumination is transmitted therethrough in a direction from which said at least one image of said object is being acquired.

The illumination unit can provide all of the illumination on the object being imaged, for example as in the case of indoor illumination, or may provide additional illumination to other light sources present, for example in outdoor illumination and in some types of indoor illumination. However, the ability and extent in the latter case to which it is possible to attenuate the reflectance from the object will generally be less than in the former case.

It is also possible to illuminate the object with more than one controlled illumination unit according to the invention, using one or more imaging devices to provide the feedback to the control unit to enable the localised intensities of the individual beams to be controlled. In such cases, the relative distances, illumination ratings of the illumination units, positions of the imaging devices relative to the illumination units and the object, and other factors, may be taken into account in a suitable algorithm to provide the desired control over the illumination units.

Herein, the term “object” is taken to include any one or collection of items, whether animate or inanimate, or one or more scenes, regarding which it is desired to obtain at least one image of at least a part thereof.

Herein, the term “imaging” includes, in addition to providing regular two-dimensional (2D) visual images of at least a part of an object, any form of direct or indirect optical measurement, for example reconstruction of three-dimensional (3D) surface data, and so on.

Thus, the present invention provides a novel controllable illumination system, comprising any suitable active electro optical device such as for example a spatial light modulator (SLM), such as for example a Liquid Crystal Display (LCD), Digital Light Processor (DLP) or any other suitable computer or software controllable light modulator. In such systems, the SLM, for example, is illuminated by a high brightness light source and an imaging lens is used to project the light pattern of the SLM onto the object.

Thus, in general, the object is first illuminated with a flat field uniform illumination and an imaging device acquires an image of the object surface. A processor analyzes the flat field image and the normalized reflectance of each of the pixels of the imaging system or camera is calculated. The reflectance calculation takes into account illumination non-uniformities at the edges of the field of view, SLM device (for example) as well as image sensor pixel-to-pixel non-uniformities and other effects that are fixed and not related to the object. Then, the SLM device is programmed to illuminate the object with a second illumination pattern, inverse to the object reflectance function that was calculated from the first image. For example, in areas with low reflection, the pixels or elements of the SLM device are set to yield high illumination, while in shiny areas illumination, the signal is set to be low. The resultant second image thus has a uniform signal over the entire image field, as well as a good signal-to-noise ratio for further image processing, e.g. wherein it is desired to detect the edge of the object.

A feature of the invention is that a large variation in reflectance properties of high spatial frequency as well as more global variations that are of low spatial frequency may be addressed, aided by the fact that the programmable illumination unit may have very high resolution—for example, current state of the art SLM devices have very high resolutions of more than 1000×1000 pixels.

Furthermore, the invention may also be used for applications in which it is desired to illuminate an object with non-uniform illumination, for example a uniform or random pattern such as lines, a texture or other pattern, which may be used in 3D surface reconstruction and measurement.

Standard SLM devices typically have dynamic range of 8 bits so that utilizing a standard video imaging device with 8 bits dynamic range effectively results in a system having a dynamic range of 16 bits, which is double the imaging device dynamic range. Advanced processing capabilities that are currently available coupled with fast refresh rate of the SLM devices are such that the time required for acquiring and analyzing the images is very short, and video rates of 30 frames per second can be achieved.

Thus, a method and system are provided for illuminating and imaging an object, wherein the illumination of the object is controlled by means of feedback based on the reflectance obtained from the object using one method of illumination, such as to provide a modified illumination that will result in a more uniform reflectance from the object.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a schematic illustration of the main elements of a system according to a first embodiment of the invention.

FIG. 2 is a schematic illustration of the embodiment of FIG. 1, further illustrating some of the main elements of the illumination unit thereof.

FIG. 3 compares the area illuminated by the embodiment of FIG. 1, with the image area captured thereby, and further illustrates an overlap area therebetween.

FIG. 4(a) and FIG. 4b illustrate the mapping of the overlap area in FIG. 3 onto the active elements of the LCD of the embodiment of FIG. 2, and onto the sensing face of the image acquisition device of FIG. 2, respectively.

FIGS. 5(a) and 5(b) illustrate a flat field uniform illumination, and the reflectance distribution obtained, respectively; FIGS. 5(c) and 5(d) illustrate a modified illumination, based on the reflectance illustrated in FIG. 5(b), and the reflectance distribution obtained, respectively.

FIGS. 6(a) and 6(b) illustrate the modified illumination of FIG. 5(c) used for illuminating an object, and the reflectance distribution obtained therefrom, respectively; FIGS. 6(c) and 6(d) illustrate a modified illumination, based on the reflectance illustrated in FIG. 6(b), and the reflectance distribution obtained, respectively.

FIG. 7 illustrates schematically a modified geometric calibration setup for multiple planes for a 3D object.

FIG. 8 is a schematic illustration of the main elements of a system according to a variation of the first embodiment of the invention.

FIG. 9 is a schematic illustration of the main elements of a system according to a second embodiment of the invention.

FIG. 10 is a schematic illustration of the main elements of a system according to a variation of the second embodiment of the invention.

### DETAILED DESCRIPTION OF EMBODIMENTS

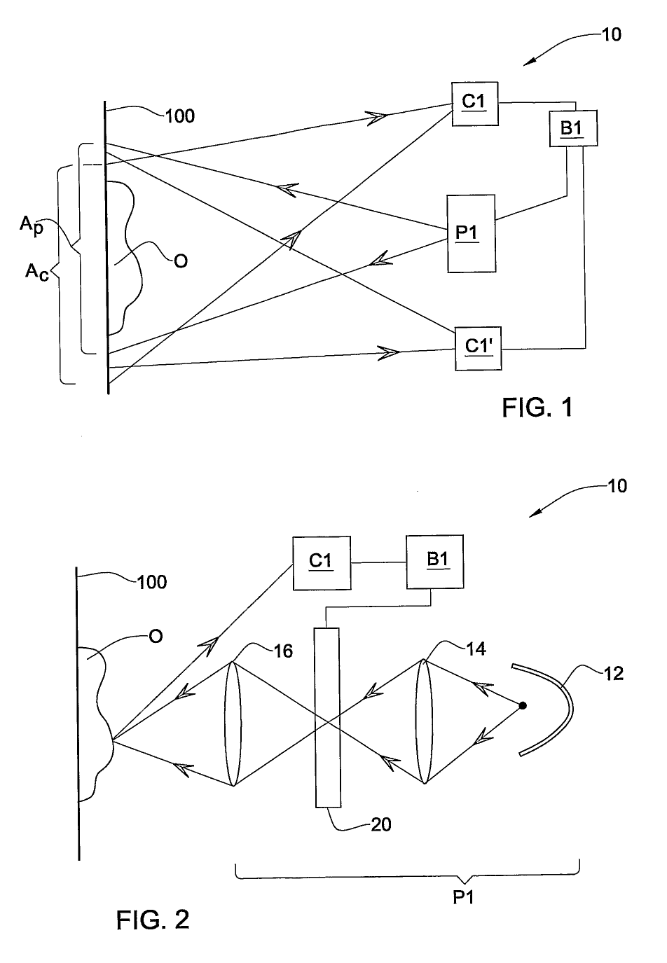

In a first embodiment of the invention, a system for illumination and imaging, illustrated in FIGS. 1 and 2, and generally designated with the reference numeral 10, comprises a controllable illumination unit P1, at least one imaging device C1 (in FIG. 1, an additional imaging device C1′ is also shown), and an illumination control unit B1 operatively connected or coupled to the imaging device(s) and to the illumination unit P1. According to this embodiment, the system is set up such that illumination radiation from illumination unit P1 projected to an object is reflected (generally non-specularly) thereby towards one or more imaging devices C1, C1′, wherein an image taken of the object by the imaging device comprises reflectance data associated with the object.

Referring in particular to FIG. 2, the controllable illumination unit P1 comprises an illumination source 12, a focusing optics 14, and a spatial light modulator (SLM) such as for example a controllable Liquid Crystal Display (LCD) device 20 through which light from the illumination source 12 passes on the way to a projection lens 16, such as for example an imaging lens used projecting the illumination pattern radiation (provided by the LCD screen) onto the object O. Such LCD devices are well known, and a large variety thereof are generally commercially available in a range of aspect ratios, sizes, dynamic response characteristics, and so on.

The illumination source 12 is in optical communication with LCD device 20, and may comprise any suitable electromagnetic radiation illuminator, for example such as any suitable high brightness light source, including, for example a lamp, laser arrangement or LED arrangement. The illumination source 12 may project an illumination radiation or light, comprising monochromatic illumination light, or a broad band illuminating radiation comprising multiple spectral wavelengths, such as the entire range of the visible spectrum, or selected range(s) of wavelengths therefrom, but may instead or in addition thereto project ultraviolet and/or infrared wavelengths to the object O.

The LCD device 20 comprises an array or matrix of individually controllable active optical elements, specifically LCD elements, each of which can be electronically controlled to have a light transmitivity varying substantially anywhere between two extremes states: “MIN”, whereby the LCD element is minimally transparent, and thus at its darkest, and does not allow substantially any light to pass therethrough from the illumination source 12; and “MAX”, whereby the LCD element is substantially fully or maximally optically transparent, allowing a corresponding portion of the illumination radiation to pass therethrough from the illumination source 12 to illuminate a particular part of the object O. At settings of the LCD elements intermediate between “MAX” and “MIN”, the elements are only partially darkened and partially transparent, allowing some light to go through, and thus providing a “grey scale” effect. The actual transparency level will depend on the amount by which the particular LCD element is activated, by means of applied voltage thereto. Such an array may comprise, for example, standard resolutions and formats including, for example, 800×600 (SVGA), 1024×768 (XGA), 1280×1024 (SXGA), 1600×1200 (UXGA), and so on, or indeed non-standard resolutions and/or formats. As will become clearer herein, operation of the illumination unit P1, in particular each LCD element thereof, is controlled via the control unit B1 via suitable control instructions.

The imaging device C1 comprises any suitable image acquisition system capable of capturing an image of an object and converting the image into digital information, either directly, or via the control unit B1, for example a video or digital camera, CCD device, or CMOS device. The imaging device C1 has a sensing face that may comprise a plurality of optical sensing elements, in which information relating to the intensity, wavelength and other properties of electromagnetic radiation impinging in the element is converted into transmittable digital or electronic data. (As will become clearer herein, though, more than one imaging device may be used with the system 10, for example two imaging devices C1, C1′ illustrated in FIG. 1, or even more imaging devices.)

The control unit B1 comprises a suitable electronic processor, for example a computer, capable of receiving electronic or digital images from the imaging device C1, and of analyzing the received images to determine zones or areas of the image in which the received light intensity is higher or lower, and by how much, relative to some mean value. The control unit B1 is further capable of manipulating the results of such analyses, such as to provide suitable control instructions to the LCD device 20, as is disclosed in greater detail herein.

According to the invention, the object O is illuminated by illumination unit P1, and imaging device C1 obtains at least one image of the object O. The control unit B1 processes the image and assesses the intensity distribution across the image, and determines the areas in the image (if any) where there is excessive reflectance (or bright spots etc.) or where the image is too dark, according to predetermined criteria. The criteria may include, for example, a received light intensity on a particular sensing element of the imaging device C1 that is beyond a predefined threshold, or where such a light intensity is greater than or less than a particular percentage of the mean intensity of the light received across the whole sensing face of the imaging device C1. Based on this analysis, control unit B1 then provides control instructions to the LCD device 20 so that the illumination beam projected therethrough onto the object O is modified to have some parts of the illumination radiation brighter than others, such that when the beam now impinges onto the object O, the areas thereof that originally appeared dark are now more brightly illuminated and thus appear brighter, while the areas that previously appeared too bright are now less brightly illuminated. Thus, for example, where a part of the illuminating beam previously caused a “bright spot” on object O of maximum brightness, the LCD element(s) through which this part of the beam traverses are now at “MIN”, and the light is thus effectively cut off from this part of the illumination beam, substantially reducing the reflectance from the corresponding part of the object O. In a similar manner, each LCD element is controlled to allow an amount of light therethrough such as to provide an intensity at a particular area on the object in inverse relationship to the intensity of the reflectance at the same area previously determined.

If there are particularly dark spots or areas in the original image that are undesirable, it may be possible to overcome this as follows. First, the intensity of the illumination light is increased at source, i.e., at illumination source 12 (if this is in fact also controllable), and another image is taken to determine the new reflectance distribution over the object O as seen in the image taken by imaging device C1. This can be repeated any number of times until the intensity of the reflected light from the darkest spot on the object O is at an acceptable level. Then, the intensity distribution obtained from this last image of the object O is further analysed to identify undesired bright regions, and the LCD device 20 is controlled as previously described in order to control the illumination reaching the object O to provide a more uniform reflectance therefrom.

Thus, the entire illumination signal can be normalized so that the darkest spots will now receive a 100% transmission of illuminating light via the appropriate LCD elements, and the brighter areas will receive less light. Effectively, the initial illumination pattern may undergo a non-linear transformation.

Another image can now be taken of the object O by imaging device C1, the illumination unit P1 having been commanded to adjust the intensity of the illuminating beam in a substantially inverse manner to the light intensity distribution in the original image, and this time the reflectance of object O as seen in the new image will be more uniform than with the previous illumination.

Such control of the illumination unit P1 can be performed once, when dealing with some static objects, for example, or repeatedly, when dealing with some moving objects, for example. In the latter case, it is possible to use the illumination distribution of the latest received image to provide the control to the LCD device 20 for the next image, and thus may be performed in substantially real time, even when the images are received as a video feed, when the acquisition and processing time for the images is short compared with the distance the object moves during this time, i.e. the object velocity.

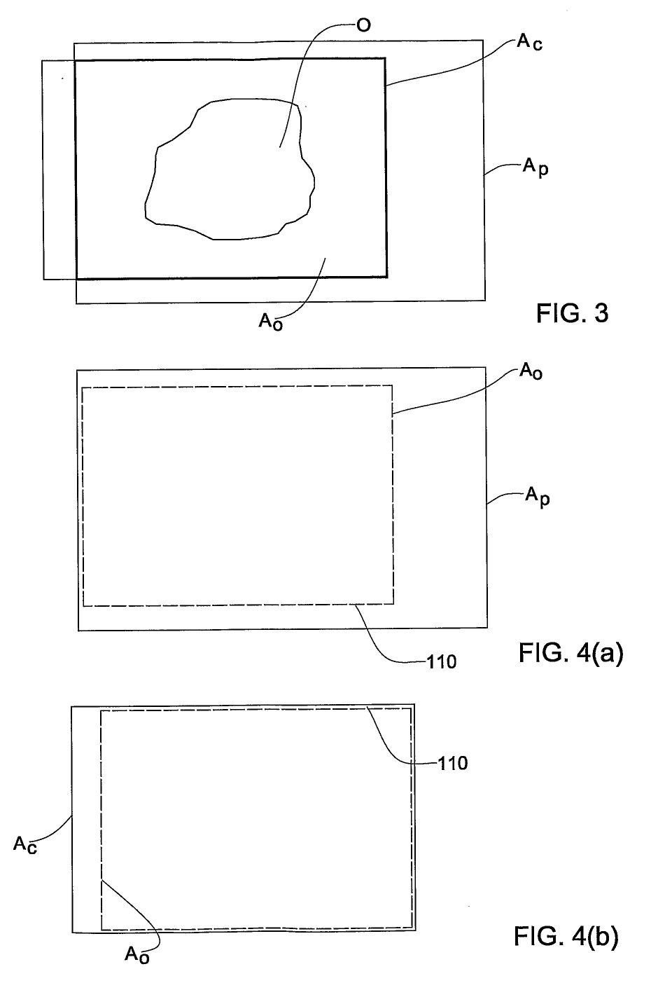

As illustrated in FIGS. 1 and 3, the illumination unit P1 actually illuminates an area A_{P} (at or near a reference plane 100 associated with the object O, though such a plane may be imaginary or may be defined on a background surface, and optionally not present when carrying out the reflectance measurements) which is generally such as to include or encompass the particular parts of the object O that need to be illuminated for subsequent imaging. The actual size of area A_{P} relative to the size of the object O will generally depend on the angular field of view (FOV) of the projection lens 16 and position of the illumination unit P1 relative to the object O. Similarly, imaging device C1 will capture images corresponding to an area A_{C} which, depending on the angular width of the field of view of imaging device C1 and position of the imaging device C1 relative to the object O, encompasses the particular parts of the object that are being illuminated by the unit P1 and which require to be imaged. As may be readily understood, while A_{C} and A_{P} are preferably about the same size and in registry one with the other to provide optimal resolution and illumination, it is possible for A_{P} and A_{C} to be of different sizes and shapes, and also to partially overlap.

To avoid such overlapping, the relative positions of the illumination unit B1, imaging device C1 and object O, and other factors may sometimes be controlled so that the areas A_{C} and A_{P} are substantially overlying one another, and this may checked and adjusted, possibly manually, if desired.

In many cases, though, it is not possible to avoid mismatching of the areas A_{C} and A_{P} to some extent, and accordingly, in such cases a geometric calibration may first be conducted on the system 10 relative to a particular object reference plane, for example plane 100, such as to determine how the illumination distribution obtained by the sensing elements the imaging device C1 corresponding to area A_{C} is mapped to the LCD elements of the illumination unit P1 such as to provide the required control over the illumination of corresponding parts of the area A_{P}. The object reference plane 100, for example, may serve as a backdrop or background for the object being imaged, or may comprise a plane, generally orthogonal to the optical axis of the imaging device C1 or of the illumination unit P1 and that passes passing through the geometric center of gravity of the object or at some other convenient geometric relationship thereto. The plane 100 may be independent from the object being imaged, and thus after the geometric calibration is performed the plane 100 (if defined by a physical surface, for example) can be removed entirely.

The geometric calibration may be performed before the start of illumination intensity measurements, and may be carried out in a number of different ways. The geometric calibration may be generally based on determining the delineation or border 110 of the area A_{O} defined by the overlap between the areas A_{C} and A_{P}, and then mapping this border 110 onto the LCD device 20 and to the sensing face of imaging device C1. One way of determining this border overlap area A_{O} in an automated manner is to control the LCD device 20 such as to produce a particular identifiable black and white (or other suitable monochromatic or multi-colour), optionally high contrast geometric image onto plane 100 (that is, without the object O), and the image obtained by the imaging device C1 is compared by control unit B1 with a comparison image corresponding to that which would be produced by the LCD device 20 if this were to be exactly captured by the sensing face of imaging device C1, assuming that aspect ratio of the LCD device 20 matches that of the sensing face of imaging device C1. If the aspect ratios are different, then the comparison image may be aligned with respect to one or another of the length and breadth of the sensing face of imaging device C1. In general, the greater the detail and randomness of the geometric image, the higher the accuracy in determining the border 110. In practice, given the extent of the image captured by imaging device C1, it is then attempted to determine how this image compares or relates to the original geometric image generated by the LCD device 20. Referring to FIG. 4(b) this border 110 will now define an active portion or window A_{C′} of the sensing face of the imaging device C1 that represents the part of area A_{C} enclosed by border 110, and thus illumination data from the particular sensing elements in this area of the sensing face are to be analysed to provide feedback control to the LCD device 20. Similarly, and referring to FIG. 4(a), this border 110 will also define an active portion or window A_{P′} of the LCD device 20, corresponding to a part of area A_{P} within border 110 that has an effect on the images captured in active area or window A_{C′} of the sensing face of imaging device C1.

Thus, each LCD element in LCD device 20 in an area thereof corresponding to window A_{P′} may be geometrically associated with one or more sensing elements of the imaging device C1 comprised in a zone or area of the sensing face thereof corresponding to window A_{C′}.

Next, a basic white illumination calibration may be carried out to compensate for a number of factors that may be present in the system and not related to the object O itself, and may be affecting the operation thereof. Such factors may include one or more of the following, for example:—

(i) “fixed non-uniformity” of the illumination unit P1 and/or of the imaging device C1, for example arising from non uniformity (along planes orthogonal to the optical axis) of the light generated by light source 12, or as modified by passage through optics 12, 16 or even LCD device 20 (when all the LCD elements are not in the “MIN” state), or for example arising from non-uniformity between the sensing elements of the imaging device C1;

(ii) non-linearity in the response characteristics of the LCD elements and/or the sensing elements of the imaging device C1;

(iii) cross talk between adjacent sensing elements of the imaging device C1.

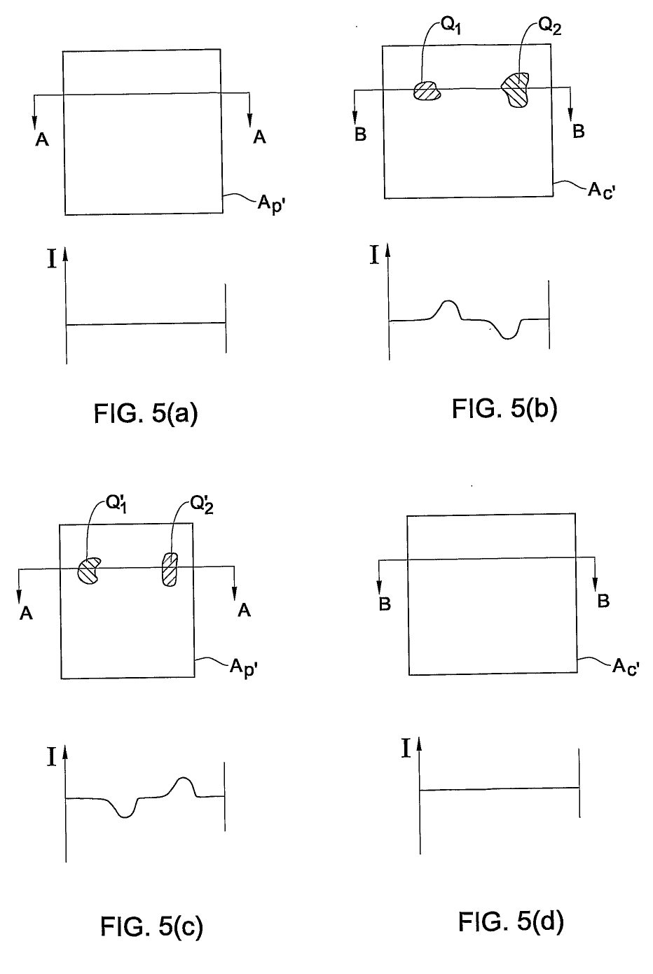

For the purposes of the basic white illumination calibration, a standard calibration object, having a substantially uniform reflectance over the surface that is to be illuminated, is placed at or near plane 100, and is illuminated by illumination unit P1, all the LCD elements of LCD device 20 being set in the “MAX” mode. (The calibration is typically carried out with respect to the active windows A_{P′} and A_{C′}, but may be extended, mutatis mutandis, for the full sensing area A_{C} and projection area A_{P}.) This illumination, which is substantially a nominally uniform illumination, is schematically illustrated in FIG. 5(a), wherein the upper illustration shows the active area or window A_{P′} of the LCD device 20, and the lower illustration shows the nominal intensity of the illumination provided along a representative section AA of the active area A_{P′} of the LCD device 20. FIG. 5(b) illustrates an image of the calibration object as seen by the sensing elements in active window A_{C′} of the imaging device C1, which is transmitted as electronic or digital data to control unit P1. After analysis by control unit P1, and by way of non-limiting example, it is determined that there is a bright patch Q1 and a dark patch Q2. The intensity distribution along a representative section BB of the window A_{C′} of sensing face of C1 is as shown in FIG. 5(b), wherein section BB of the window A_{C′} of imaging device C1 maps to section AA of window A_{P′} of the LCD device 20. The control unit B1 then creates and sends an appropriate command to the LCD device 20 such as to attenuate the illumination intensity passing through every LCD element in the active window A_{P′} in inverse relationship to the brightness distribution provided by the image in active window A_{C′}. For example, and as illustrated in FIG. 5(c), the overall intensity of the illumination source 12 and the LCD elements are adjusted so as to provide an illumination profile along section AA that is the inverse of the previously-received brightness distribution at section BB, and thus providing relatively brighter portion Q2′ and relatively darker portion Q1′. When the thus-modified illumination is projected to the calibration object, the reflectance therefrom is substantially uniform, or at least more uniform than before, and these illumination conditions become the reference or nominal baseline conditions, which are subsequently used for illuminating object O.

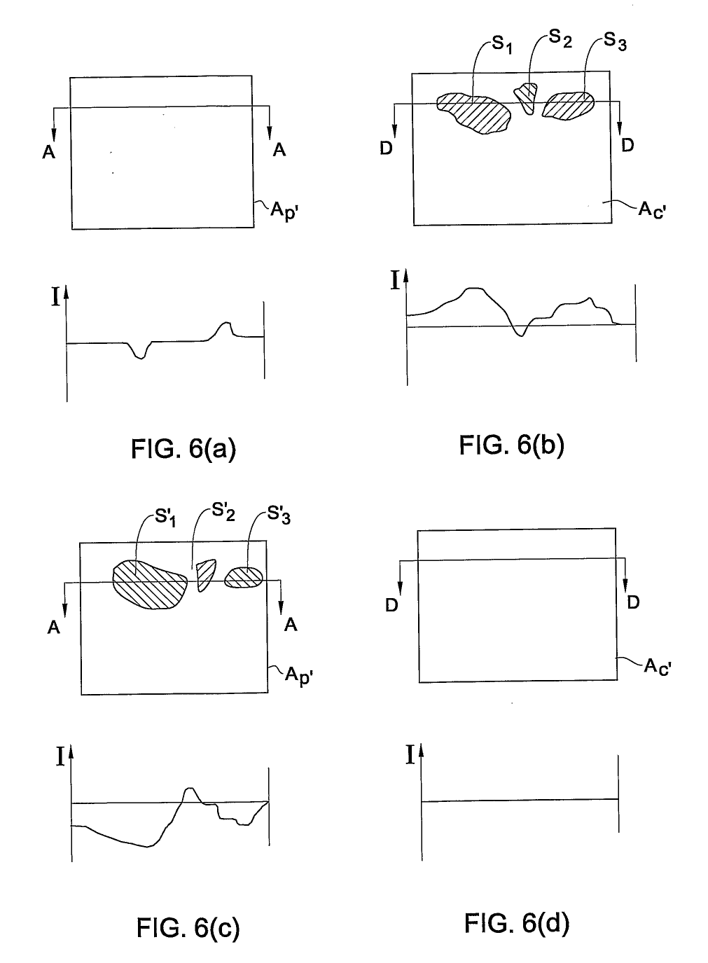

With the object O now at a position at or near plane 100, such that the desired part(s) of the object are within border 110 when viewed by imaging device C1, the illumination unit P1 illuminates the object O at the aforesaid baseline conditions, represented by FIG. 6(a), which is substantially identical to FIG. 5(c). Imaging device C1 captures and records a baseline image of the object O, as illustrated in FIG. 6(b), which, by way of a non-limiting example, comprises two bright regions or zones S1, S3, and a relatively dark region or zone S2 as seen in the active window A_{C′}. In a similar manner to the white illumination calibration, mutatis mutandis, the electronic or digital information corresponding to this image is sent to the control unit B1, and the brightness distribution thereof analysed to create suitable command signals to active window A_{P′} of the LCD device 20 (and optionally raising the overall intensity of the light projected by source 12 to correct for the dark zone). Thus, the active window A_{P′} thereof (and optionally the illumination unit 12) are operated by control unit B1 in a manner so as to attenuate the light passing therethrough from the illumination source 12 in an inverse manner to the intensity distribution corresponding to the baseline image. For example, referring to FIG. 6(c), the intensity distribution created by operation of the active window A_{P′} of LCD device 20 at representative section AA is the inverse of the brightness distribution of the baseline image along representative section DD thereof, wherein section DD of the baseline image maps to section AA of the active window A_{P′} of LCD device 20, according to the aforementioned geometric calibration, and thus providing relatively brighter portion S2′ and relatively darker portions S1′ and S3′.

Under these modified illumination conditions, the imaging device C1 captures or records another image, wherein the reflectance received from object O, as illustrated in FIG. 6(d), is substantially more uniform than that corresponding to the baseline image illustrated in FIG. 6(b).

When the object O is relatively flat and parallel to the plane 100, a simple geometric correspondence as described above may be used for accurately mapping the window A_{C′} to window A_{P′}. Preferably, the geometric calibration also takes into account optical deviations that may originate from distortions of the projecting and imaging lenses. If the magnification and resolution of the LCD device 20 matches those of the sensing face of the imaging device C1, then changes in magnification are the same in both devices, and each pixel in the LCD device 20 corresponds to a pixel of the sensing face of the imaging device C1, regardless of the distance between each of these components and the object O.

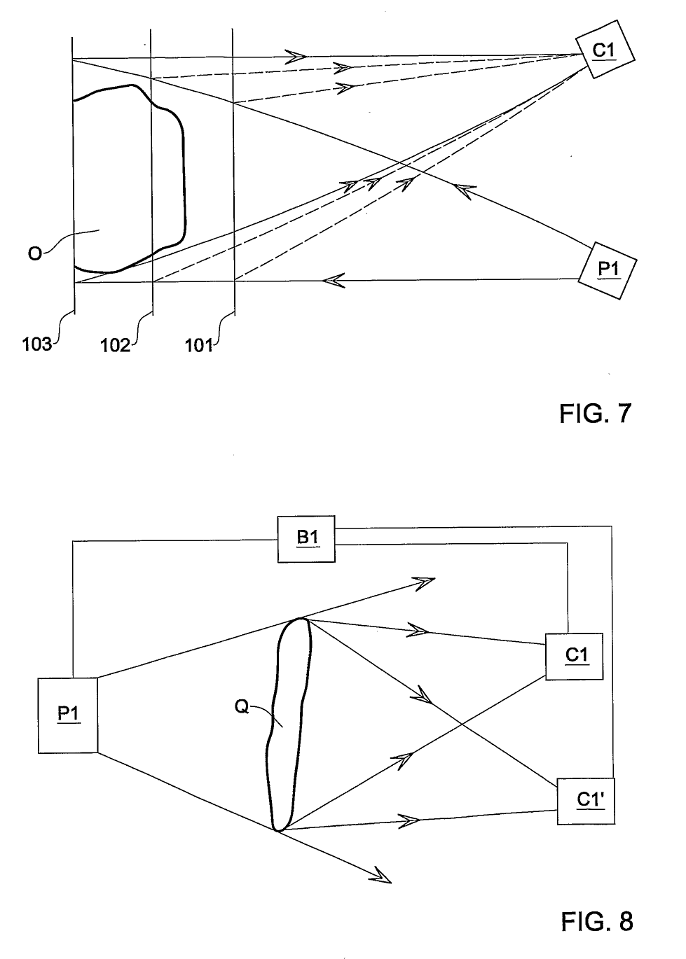

In other cases, for example where the object has pronounced 3D attributes and large variations in depth dimensions, a modified geometric calibration may be more useful than the above. For example, referring to FIG. 7, a geometric calibration, similar to the one described above, is carried out at each one of three different planes 101, 102, 103, typically parallel spaced planes, such that the object O is defined between the closest plane 101 and the furthest plane 103 with respect to the illumination unit P1 or the image acquisition unit C1. Plane 102 may optionally be somewhere close to the geometric center of gravity of the object O, for example, and the geometric mapping obtained for this plane is initially used for providing the feedback data for controlling the illumination of the object O. If it is found that a particular area of the image is unaffected, or affected much less than surrounding areas, or is affected in the opposite manner to that desired, then it may be so because the particular height or depth of the area of the object O is being affected by a different part of the LCD device 20 than would have been the case had this area been at plane 102. Then, another attempt is made at providing feedback data, but this time at least a part of the LCD device 20 is controlled via feedback information using the geometric mapping previously obtained, for this part at least, at plane 101 or 103. A number of iterations may be carried out, each time varying the zone in the corresponding window A_{C′} or window A_{P′} corresponding to these planes. Of course, this methodology may be extended to any number of geometric calibration planes.

As illustrated in FIG. 1, more than one imaging device may be used for imaging object O, for example a second imaging device C1′ in addition to the first imaging device C1. The second imaging device C1′ can be operatively connected to control unit B1, and a geometrical calibration and a basic white illumination calibration can be performed therefore in a similar manner to that performed for imaging device C1, mutatis mutandis. Then, either imaging device C1 or imaging device C1′ can be used to provide feedback to reconfigure the LCD device 20 to provide the optimal conditions such as to minimize reflectance variations as seen from the chosen imaging device, while both imaging devices may be used for imaging, optical measurements and so on. The image obtained in the other imaging device may not be as well adjusted in terms of reflectance variations as the chosen imaging device, and in general the further away the second imaging device is from the chosen imaging device, the more likely that this difference between the reflectance quality of the images may increase. In other words, while only one imaging device is used for calibrations, all the imaging devices may be used for imaging, optical measurements etc.

Alternatively, the images from both imaging devices, i.e., from the active windows A_{C′} of each one thereof, may be analysed by the control unit B1, and the brightness distributions obtained, when illuminated at the aforesaid baseline illumination conditions, may be combined to provide a synthesized brightness distribution, which is then used by the control unit B1 to operate the LCD device 20 in a similar manner to that described earlier, mutatis mutandis. In such a case, it is also possible to perform the basic white illumination calibration using feedback data from images of the calibration object obtained from both imaging devices, mutatis mutandis.

In other variations of this embodiment, three or more imaging devices may be used in a similar manner to that described, mutatis mutandis.

In a variation of the first embodiment, the LCD device 20 is replaced with a Liquid Crystal on Silicon (LCOS) device, mutatis mutandis. The LCOS device essentially comprises a mirror mounted on the surface of a chip, overlaid on an array or matrix of individually controllable liquid crystal elements, which control the light being reflected to the object O or plane 100.

A variation of the first embodiment of the invention, illustrated in FIG. 8, comprises the elements and features as described for the embodiment of FIG. 1, mutatis mutandis, including one or more imaging devices, C1, C1′, operatively connected to control unit B1, and illumination unit P1. However, according to this variation of the first embodiment, the system is set up such that illumination radiation from illumination unit P1 projected to an object Q is transmitted, at least partially, therethrough thereby towards one or more imaging devices C1, C1′, wherein an image taken of the object by the imaging device comprises transmittance data associated with the object.

A geometric calibration may be performed in a similar manner to that of the embodiment of FIG. 1, the main difference being that rather than a reflective plane 100, a substantially transparent or translucent plate may be provided at one or a number of planes that may be associated with the object Q, and the corresponding active windows A_{C′} and A_{P′}, are determined therefrom. A translucent or transparent plate having a particular pattern, for example a rectangular grid, may be helpful in determining the active windows A_{C′} and A_{P′}. Further, for the purposes of the white illumination calibration, a uniformly translucent plate may be used as a standard calibration object, wherein the illumination light is transmitted therethrough rather then reflected therefrom as in the embodiment of FIG. 1, mutatis mutandis.

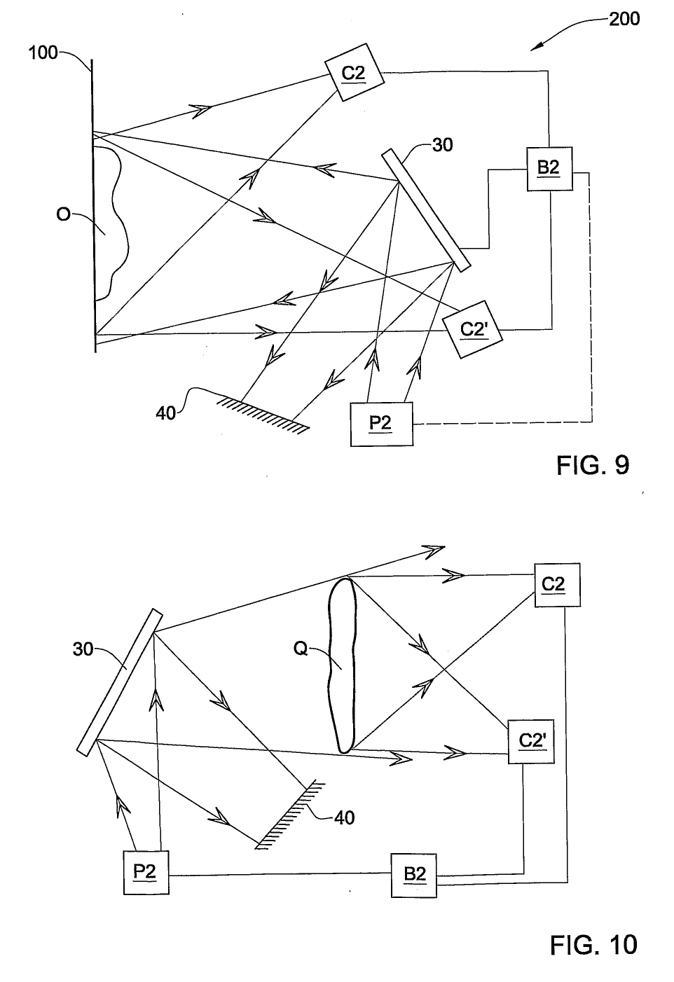

A second embodiment of the invention, illustrated in FIG. 9, comprises the elements and features as described for the first embodiment, mutatis mutandis, with some differences as will become apparent herein. Thus, the system 200, according to the second embodiment, also comprises one or more imaging devices, C2, C2′, operatively connected to control unit B2, similar to the imaging devices and control unit of the first embodiment, mutatis mutandis. However, the illumination unit of the first embodiment, in particular including the LCD arrangement, is replaced in the second embodiment with a suitable digital light processing (DLP) arrangement, such as for example a digital micro-mirror device (DMD) 30, operatively connected to the control unit B2, and an illumination unit P2, which is optionally also operationally connected to control unit B2.

Such DMD's are well known devices and are generally available commercially. Essentially, the DMD 30 comprises an array or matrix of individually controllable micro-mirror elements each of which can be oriented in one of two directions or orientations. Such an array may comprise, for example, SVGA(800×600), XGA(1024×768), SXGA(1400×1050), VGA(640×480), 720p(1280×720), 1080p(1920×1080), 1024×576, 1280×1080, 1600×1200, 2048×1080, 848×600, 848×480, and so on, micro-mirror elements. In one such orientation, herein denoted as mode “ON”, the micro mirror element in DMD 30 reflects light from the illumination unit P2 incident thereon towards the object O to illuminate a particular part of the object O, while at the other orientation, herein denoted as mode “OFF”, the micro mirror element reflects light from the illumination unit P2 incident thereon towards a black surface 40, and away from the object O, and thus does not illuminate the corresponding particular part of the object O. Each micro mirror element is controlled via the control unit B2.

A geometrical calibration can be performed for system 200, in particular the DMD 30 and one or more imaging devices, C2, C2′, in a similar manner to that performed for the first embodiment, particularly the LCD device and imaging device(s) thereof, mutatis mutandis, with the major difference being that rather than using a geometric image produced by the LCD device 20, such an image may be created by suitably programming the DMD 30 to selectively reflect light towards the plane 100 at corresponding micro mirror elements of the DMD 30.

Then, a basic white illumination calibration can be performed for system 200 in a similar manner to that performed for the first embodiment, mutatis mutandis, with the major difference being that rather than changing the applied voltage to LCD elements responsive to feedback signals created by the control unit B1 based on the brightness distribution to generate the appropriate level of darkening, individual micro mirror elements are controlled by the control unit B2 to switch between modes “ON” and “OFF”, so as to provide baseline illumination conditions.

Furthermore, depending upon the intensity of the reflected light in a particular bright spot on the image, it may be possible to attenuate the brightness of the corresponding part of the illumination beam passing through the DMD device 30 in a graduated manner. In this connection, use is made of the integration time T of the sensing elements of the imaging device C2, i.e., the minimum time period required for enabling a reading to be completed by the sensing element. According to the brightness of the bright spot, the corresponding DMD micro mirror element(s) may be switched “ON” for a time t, and “OFF” for a time (T−t), so that the light intensity reaching these sensing elements of the imaging device will be attenuated by (T−t)/T: the brighter the bright spot in the original image, the lower the time t, and thus the lower the integrated intensity of the light received by the corresponding sensors of imaging device C2. For a given “ON” time t (less than T), the corresponding DMD micro mirror elements of DMD device 30 may be “OFF” continuously for time (T−t), or within time T may alternate periods of “ON” and “OFF” such as the total time “OFF” is (T−t). In this manner it is possible for the DMD micro mirror elements to provide a “grey effect”.

Finally, and using the established baseline illumination conditions, the system 200 can be operated in a similar manner to the first embodiment, mutatis mutandis, to illuminate the object O and obtain images thereof from one or more imaging devices, with the major difference being that rather than controlling the LCD elements between the “MAX” and “MIN” extremes responsive to feedback signals created by the control unit B1 based on the brightness distribution, individual micro mirror elements of the DMD device 30 are controlled by the control unit B2 to switch between modes “ON” and “OFF”, and optionally remaining at the “ON” mode for a time t less than or equal to T.

A variation of the second embodiment of the invention, illustrated in FIG. 10, comprises the elements and features as described for the embodiment of FIG. 9, mutatis mutandis, including one or more imaging devices, C2, C2′, operatively connected to control unit B2, and illumination unit P2. However, according to this variation of the first embodiment, the system is set up such that illumination radiation from illumination unit P2 projected to an object Q is transmitted, at least partially, therethrough towards one or more imaging devices C2, C2′, wherein an image taken of the object by the imaging device comprises transmittance data associated with the object.

A geometric calibration, and a white illumination calibration, can be performed in a similar manner to those described for the embodiment of FIG. 8, mutatis mutandis.

In the method claims that follow, alphanumeric characters and Roman numerals used to designate claim steps are provided for convenience only and do not imply any particular order of performing the steps.

Finally, it should be noted that the word “comprising” as used throughout the appended claims is to be interpreted to mean “including but not limited to”.

While there has been shown and disclosed exemplary embodiments in accordance with the invention, it will be appreciated that many changes may be made therein without departing from the spirit of the invention.

1. An illumination system for controlling illumination of an object, comprising:
(a) at least one programmable illumination unit capable of projecting an illumination radiation with respect to an object, said illumination unit being adapted for enabling portions of said illumination radiation to be individually controlled via suitable control instructions;
(b) at least one image acquisition device for acquiring at least one image of an object illuminated by said illumination unit; and
(c) a control unit operatively connected to said at least one illumination unit and said at least one imaging device, said control unit being configured for creating control instructions for controlling operation of said at least one illumination unit based on analysis of at least one image obtained from said at least one imaging device.

2. An illumination system according to claim 1, wherein said at least one programmable illumination unit comprises at least one illumination source capable of projecting an illumination radiation in optical communication with a plurality of optical elements, said optical elements being individually controllable via said suitable control instructions such that each optical element is capable of being selectively controlled for enabling or blocking projection of a corresponding portion of said illumination radiation with respect to an object that is to be illuminated by said illumination unit.

3. An illumination system according to claim 2, wherein said illumination unit is adapted for controlling the intensity of illumination of a corresponding part of the object at least as sensed by said at least one image acquisition device.

4. An illumination system according to claim 2, wherein said at least one illumination unit comprises a plurality of optical elements configured for selectively allowing or preventing optical communication therethrough of said illumination radiation with respect to an object, responsive to said control instructions.

5. An illumination system according to claim 4, wherein said at least one illumination unit comprises a liquid crystal display (LCD) array in optical communication with said illumination source, and comprising a plurality of LCD elements individually controllable responsive to said control instructions to selectively control optical communication therethrough between a portion of said illuminating radiation and an object.

6. An illumination system according to claim 5, wherein said LCD elements are individually controllable via said control instructions such as to provide a range of levels of optical transparencies between a minimum value, in which the corresponding LCD element allows substantially no illumination light therethrough, and a maximum value, in which the maximum illumination intensity is allowed to be projected therethrough towards the object.

7. An illumination system according to claim 2, wherein said at least one illumination unit comprises a digital light processing (DLP) arrangement comprising a plurality of optical elements configured for selectively reflecting towards or away with respect to an object, a portion of said illumination radiation, responsive to said control instructions.

8. An illumination system according to claim 7, wherein said at least one illumination unit comprises a digital micro-mirror device (DMD) in optical communication with said illumination source, and comprising a plurality of micro-mirror elements individually controllable responsive to said control instructions to selectively direct a portion of illumination radiation towards or away from an object.

9. An illumination system according to claim 8, wherein said micro-mirror elements are individually controllable via said control instructions such as to attenuate the intensity of illumination light projected to the object, wherein each corresponding micro-mirror element is controlled to direct said illumination radiation towards the object for a proportion of an integration time of said at least one image acquisition device.

10. An illumination system according to claim 2, wherein said control unit is adapted for creating control instructions that enable the at least one illumination unit to project, with respect to an object, an illumination having a brightness distribution that is generally inverse to the radiation intensity distribution of an image obtained from said at least one image acquisition unit when said object is illuminated with an illumination having a generally uniform brightness distribution.

11. An illumination system according to claim 2, wherein said control unit is adapted for creating control instructions that enable the at least one illumination unit to project, with respect to an object, a structured illumination wherein it is desired to illuminate an object with non-uniform illumination.

12. An illumination system according to claim 2, wherein said at least one programmable illumination unit is arranged such as to illuminate a surface of an object, and said at least one image acquisition device is arranged with respect to the object such as to provide an image of at least a part of said surface, said image being analyzable to determine associated reflectance data for use in creating said control instructions.

13. An illumination system according to claim 2, wherein said at least one programmable illumination unit is arranged such as to provide illumination through at least a part an object, and said at least one image acquisition device is arranged with respect to the object such as to provide an image of at least a portion of said part of the object said image being analyzable to determine associated radiation transmission data for use in creating said control instructions.

14. An imaging system for imaging an illuminated object, comprising:
(a) at least one programmable illumination unit capable of projecting an illumination radiation with respect to an object, wherein portions of said illumination radiation are individually controllable via suitable control instructions;
(b) at least one image acquisition device for acquiring images of an object illuminated by said illumination unit; and
(c) a control unit operatively connected to said at least one illumination unit and said at least one imaging device, said control unit being configured for creating control instructions for controlling operation of said illumination unit based on at least one image obtained from said at least one imaging device.

15. An imaging system according to claim 14, wherein said at least one programmable illumination unit comprises at least one illumination source capable of projecting an illumination radiation in optical communication with a plurality of optical elements, said optical elements being individually controllable via said suitable control instructions such that each optical element is capable of being selectively controlled for enabling or blocking projection of a corresponding portion of said illumination radiation with respect to an object that is to be illuminated and imaged by said system.

16. An imaging system according to claim 15, wherein said illumination unit is adapted for controlling the intensity of illumination of a corresponding part of the object at least as sensed by said at least one image acquisition device.

17. An imaging system according to claim 15, wherein said at least one illumination unit comprises a plurality of optical elements configured for selectively allowing or preventing optical communication therethrough of said illumination radiation with respect to an object, responsive to said control instructions.

18. An imaging system according to claim 17 wherein said at least one illumination unit comprises a liquid crystal display (LCD) array in optical communication with said illumination source, and comprising a plurality of LCD elements individually controllable responsive to said control instructions to selectively allow or prevent optical communication therethrough between a portion of said illuminating radiation and an object.

19. An imaging system according to claim 18, wherein said LCD elements are individually controllable via said control instructions such as to provide a range of levels of optical transparencies between a minimum value, in which the corresponding LCD element allows substantially no illumination light therethrough, and a maximum value, in which the maximum illumination intensity is allowed to be projected therethrough towards the object.

20. An imaging system according to claim 15, wherein said at least one illumination unit comprises a digital light processing (DLP) arrangement comprising a plurality of optical elements configured for selectively reflecting towards or away a portion of said illumination radiation with respect to an object, responsive to said control instructions.

21. An imaging system according to claim 20, wherein said at least one illumination unit comprises a digital micro-mirror device (DMD) in optical communication with said illumination source, and comprising a plurality of micro-mirror elements individually controllable responsive to said control instructions to selectively direct a portion of illumination radiation towards or away from an object.

22. An imaging system according to claim 21, wherein said micro-mirror elements are individually controllable via said control instructions such as to attenuate the intensity of illumination light projected to the object, wherein each corresponding micro-mirror element is controlled to direct said illumination radiation towards the object for a proportion of an integration time of said at least one image acquisition device.

23. An imaging system according to claim 15, wherein said control unit is adapted for creating control instructions that enable the at least one illumination unit to project, with respect to an object, an illumination having a brightness distribution that is generally inverse to the radiation intensity distribution of an image obtained from said at least one image acquisition unit when said object is illuminated with an illumination having a generally uniform brightness distribution.

24. An imaging system according to claim 15, wherein said control unit is adapted for creating control instructions that enable the at least one illumination unit to project, with respect to an object, a structured illumination wherein it is desired to illuminate an object with non-uniform illumination.

25. An imaging system according to claim 16, wherein said at least one programmable illumination unit is arranged such as to illuminate a surface of an object, and said at least one image acquisition device is arranged with respect to the object such as to provide an image of at least a part of said surface, said image being analyzable to determine associated reflectance data for use in creating said control instructions.

26. An imaging system according to claim 16, wherein said at least one programmable illumination unit is arranged such as to provide illumination through at least a part an object, and said at least one image acquisition device is arranged with respect to the object such as to provide an image of at least a portion of said part of the object said image being analyzable to determine associated radiation transmission data for use in creating said control instructions.

27. An imaging system according to claim 14, comprising a plurality of said image acquisition devices.

28. An imaging system according to claim 27, wherein said control unit is further adapted for processing images obtained from said plurality of said image acquisition devices for 3D surface reconstruction or for optical measurement of an object.

29. A method for illuminating an object, comprising:
(a) projecting a first illumination radiation with respect to an object;
(b) acquiring at least one image of said object illuminated as in step (a);
(c) analyzing said at least one image to obtain radiation intensity data associated with said image and correlated to said first illumination radiation; and
(d) projecting a second illumination radiation with respect to said object, whereby individual portions of said second illumination radiation may be modified with respect to corresponding portions of said first illumination radiation based on said radiation intensity data obtained in step (b).

30. A method according to claim 29, wherein said second illumination radiation comprises a brightness distribution in general inverse relationship with respect a radiation intensity distribution of said image radiation intensity data obtained in step (b).

31. A method according to claim 30, wherein said first illumination radiation in step (a) is defined according to the following steps:—
(i) illuminating a standard calibration object with substantially uniform illumination;
(ii) acquiring at least one calibration image of said calibration object illuminated as in step (i);
(iii) analyzing said at least one calibration image to obtain radiation intensity data associated with said image and correlated to said uniform illumination radiation; and
(iv) generating said first illumination radiation, whereby individual portions of said first illumination radiation are modified with respect to corresponding portions of said uniform illumination radiation based on said radiation intensity data obtained in step (iii).

32. A method according to claim 29, wherein said second illumination further comprises a structured illumination with which it is desired to illuminate said object.

33. A method according to claim 29, wherein, in step (d), an illuminating intensity of said portions of said second illumination radiation is directly controlled to provide a desired level of illumination at a corresponding part of the object.

34. A method according to claim 29, wherein, in step (d), an illuminating intensity of said portions of said second illumination radiation, as perceived by an image acquisition device that provides said at least one image, is controlled such as to attenuate the intensity of illumination light projected to the object, wherein each said portion of said second illumination radiation is projected towards the object for a proportion of an integration time of said image acquisition device to provide a desired level of illumination at a corresponding part of the object.

35. A method according to claim 29, wherein said first illumination radiation is projected with respect to an object such that at least a part of said illumination is reflected in a direction from which said at least one image of said object is being acquired.

36. A method according to claim 29, wherein said first illumination radiation is projected with respect to an object such that at least a part of said illumination is transmitted therethrough in a direction from which said at least one image of said object is being acquired.

37. A method for imaging an object, comprising:
(a) projecting a first illumination radiation with respect to an object;
(b) acquiring at least one first image of said object illuminated as in step (a);
(c) analyzing said at least one first image to obtain radiation intensity data associated with said first image and correlated to said first illumination radiation;
(d) projecting a second illumination radiation with respect to said object, whereby individual portions of said second illumination radiation may be modified with respect to corresponding portions of said first illumination radiation based on said radiation intensity data obtained in step (b); and
(e) acquiring at least one second image of said object illuminated as in step (d).

38. A method according to claim 37, wherein said second illumination radiation comprises a brightness distribution in general inverse relationship with respect a radiation intensity distribution of said image radiation intensity data obtained in step (b).

39. A method according to claim 37, wherein said first illumination radiation in step (a) is defined according to the following steps:—
(i) illuminating a standard calibration object with substantially uniform illumination;
(ii) acquiring at least one calibration image of said calibration object illuminated as in step (i);
(iii) analyzing said at least one image to obtain radiation intensity data associated with said image and correlated to said uniform illumination radiation; and
(iv) generating said first illumination radiation, whereby individual portions of said first illumination radiation are modified with respect to corresponding portions of said uniform illumination radiation based on said radiation intensity data obtained in step (iii).

40. A method according to claim 37, further comprising processing said at least one second image for 3D surface reconstruction or for optical measurement of an object.

41. A method according to claim 40, wherein a plurality of sets of said second image are obtained for 3D surface reconstruction or for optical measurement of an object, and wherein said second images in each set are obtained at a different viewpoints with respect to said object.

42. A method according to claim 37, wherein, in step (d), an illuminating intensity of said portions of said second illumination radiation is directly controlled to provide a desired level of illumination at a corresponding part of the object.

43. A method according to claim 37, wherein, in step (d), an illuminating intensity of said portions of said second illumination radiation, as perceived by an image acquisition device that provides said at least one image, is controlled such as to attenuate the intensity of illumination light projected to the object, wherein each said portion of said second illumination radiation is projected towards the object for a proportion of an integration time of said image acquisition device to provide a desired level of illumination at a corresponding part of the object.

44. A method according to claim 29, wherein said first illumination radiation is projected with respect to an object such that at least a part of said illumination is reflected in a direction from which said at least one image of said object is being acquired.

45. A method according to claim 29, wherein said first illumination radiation is projected with respect to an object such that at least a part of said illumination is transmitted therethrough in a direction from which said at least one image of said object is being acquired.
